(19) United States
(12) Patent Application Publication
(10) Pub. No.: US 2012/0082378 A1
(43) Pub. Date: Apr. 5, 2012

(54) METHOD AND APPARATUS FOR SELECTING A REPRESENTATIVE IMAGE

(75) Inventors: Marc Andre Peters, Eindhoven (NL); Pedro Fonseca, Eindhoven (NL)

(73) Assignee: KONINKLIJKE PHILIPS ELECTRONICS N.V., EINDHOVEN (NL)

(21) Appl. No.: 13/377,841

(22) PCT Filed: Jun. 8, 2010
(86) PCT No.: PCT/IB2010/052534

§ 371 Date: Dec. 13, 2011

(30) Foreign Application Priority Data
Jun. 15, 2009 (EP) 09162685.3

(51) Int. Cl. G06K 9/62; G06K 9/46; G06K 9/00

(52) U.S. Cl. 382/165; 382/225; 382/195

(57) ABSTRACT

A method of selecting at least one representative image from a plurality of images, the method comprising the steps of: dividing (201) the plurality of images into clusters according to a predetermined characteristic of the content of the plurality of images; selecting (203) at least one of the clusters based on the number of images in each of the clusters; and selecting (205) at least one image from the selected at least one cluster as the representative image.

### FIELD OF THE INVENTION

The present invention relates to a method and apparatus for selecting at least one representative image from a plurality of images.

### BACKGROUND TO THE INVENTION

The advances in digital technology mean that digital cameras have become increasingly popular. As a result an increasing number of digital still images (such as photographs) are being captured and stored on computers or other storage devices. These images may be shared amongst communities of users. Furthermore, since storage media have become more readily available users are less likely to delete old images. This results in an individual having access to an extensive library of images which is difficult to browse. Browsing and finding photos on any device thus becomes an increasingly important problem, especially for devices which lack convenient controlling devices (keyboard, mouse) such as photo frames or portable devices.

Many techniques have been proposed to assist a user when browsing such as creating hierarchical browsing methods or summaries of collections of images. In respect of these techniques, however, it would be desirable to have a single image that would be representative of a group of images. Preferably it should be an image that the user easily associates the group with or recognizes the group from to be representative of the group.

### SUMMARY OF INVENTION

The present invention seeks to provide a technique for obtaining from amongst a vast number of images a representative image of a group of images.

This is achieved, according to one aspect of the present invention, by a method of selecting at least one representative image from the plurality of images, the method comprising the steps of: dividing a plurality of images into clusters according to a predetermined characteristic of the content of the plurality of images; selecting at least one of the clusters based on the number of images in each of the clusters; and selecting at least one image from the selected at least one cluster as the representative image.

This is also achieved, according to a second aspect of the present invention, by apparatus for selecting at least one representative image from the plurality of images, the apparatus comprising: a divider for dividing a plurality of images into clusters according to a predetermined characteristic of the content of the plurality of images; a selector for selecting at least one of the clusters based on the number of images in each of the clusters and for selecting at least one image from the selected at least one cluster as the representative image.

In this way, images are divided into clusters. This may be achieved according to similarity, time, event or even a folder where they are located. A cluster is selected and at least one image is selected from the selected cluster. This may be a single image or a set of images which best represents the entire group of images. These representative images provide a smaller set of images which is useful in summarizing a whole collection, browsing through a collection, finding specific images, etc.

In an embodiment, the step of selecting at least one cluster comprises the step of: selecting the cluster having the largest number of images.

The idea is that the more important a certain element in a group of images is (e.g. the Eiffel Tower in a group of images from a holiday in Paris) the more images of that element will exist in the collection. Similarly, the more images there are of a specific object, the easier it will be for the user to recognize it and associate it with a specific event, time period or group of images. This enables the representative image to be selected from the cluster which is most likely to contain the most important objects and therefore to best represent the plurality of images.

If there is more that one cluster which contains the largest number of images, then a cluster may further be selected by selecting the cluster having the least amount of variation in the predetermined characteristic.

This assures that the images in the selected cluster are even more alike than in the other clusters.

In an embodiment, the step of selecting at least one image from the selected at least one cluster as a representative image comprises the step of: selecting the image closest to a centroid of the selected at least one cluster. This representative image is therefore selected as the image closest to the centroid of the cluster which is a representation (in terms of features) of, for example, the average of the images within the cluster. This provides a representative image having strong association for the user with the specific cluster. Alternatively, the image may be randomly selected.

The plurality of images may be divided into clusters by clustering images having similar characteristics, for example, visually similar such that the clusters contained related or images having similar content.

Alternatively, the plurality of images may be divided into clusters by clustering the images captured at a time within a predetermined time interval. For example, the images can be divided into a cluster of images captured on a certain day or within a vacation period. Alternatively, the images may be clustered such that the time difference between the consecutive images within a cluster is no more than a certain relatively small threshold (e.g. 2 up to 10 minutes). Such images that are captured around the same time are more likely to be of images of the same object, scene or event.

In addition, clustering images that are visually similar may be preceded by the step of: clustering images captured at time within a predetermined time interval; and the step of clustering images that are visually similar comprises the step of: clustering images of the cluster of images captured at time within a predetermined time interval that are visually similar. Using time information as a first clustering step prevents images that are semantically unrelated but visually very similar being clustered together. For example, using visual clustering only, two images of the sea captured during two different holiday trips may be clustered together.

The images may be clustered by extracting at least one feature from each of said plurality of images; determining the distance between at least one extracted feature of each of the plurality of images; and clustering images having a distance below a predetermined threshold. The at least one feature may comprise one of luminance; colour information; colour distribution features; texture features.

In this way, simple yet well tried techniques can be utilised to cluster the images.

The step of selecting at least one image from the selected at least one cluster as a representative image may comprise the steps of: determining the presence of at least one face within each of said images of said selected at least one cluster; determining the ratio of the number of images which contain at least one face to the number of images that contain no face; and selecting an image having a face if said ratio is greater than or equal to 1 or selecting an image without a face if said ratio is less than to 1.

The presence of a person, i.e. a face, within an image can provide a good basis for selecting a representative image. If most of the images in the cluster do not contain faces, the most representative image should preferably also not contain faces. Likewise, if most of the images in the cluster do contain faces, the most representative image should preferably also contain a face. As a result face detection can help identify the image or images that best represent the plurality of images.

### BRIEF DESCRIPTION OF DRAWINGS

For a more complete understanding of the present invention, reference is now made to the following description taken in conjunction with the accompanying drawings in which:

FIG. 1 is a simplified schematic of apparatus for selecting an image according to an embodiment of the present invention; and

FIG. 2 is a flowchart of a method of selecting an image according to an embodiment of the present invention.

### DETAILED DESCRIPTION OF EMBODIMENTS OF THE INVENTION

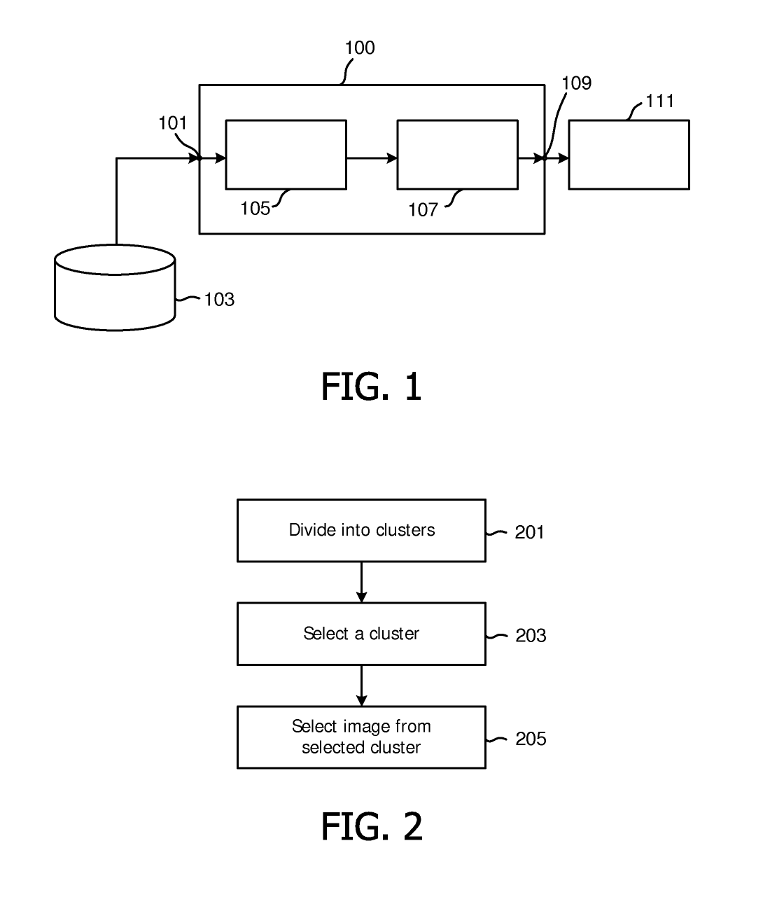

With reference to FIG. 1, the apparatus 100 comprises an input terminal 101 connected to a storage means 103. Although the storage means 103 is illustrated here as external to the apparatus 100, in an alternative embodiment, the storage means 103 may be integral with the apparatus. The storage means 103 may be a memory device of a computer system, such as a ROM/RAM drive, CD, a memory device of a camera or like device connected to the apparatus 100, or remote server. It may be accessed via a wired or wireless connection and/or accessed via a wider network such as the Internet.

The storage means 103 stores a plurality of images. Images stored on a remote server, for example, may be uploaded and temporarily stored in a local storage means (not shown here) of the apparatus 100.

The input terminal 101 of the apparatus 100 is connected to the input of a divider 105 of the apparatus 100. The output of the divider 105 is connected to the input of a selector 107 of the apparatus 100. The output of the selector 107 is connected to an output terminal 109 of the apparatus 100. The output terminal 109 is connected to a display device 111 or the like.

Operation of the apparatus will now be described with reference to FIG. 2. A plurality of images are retrieved from the storage means 103 and are provide to the divider 105 via the input terminal 101 of the apparatus 100. The plurality of images are divided into a plurality of clusters based upon a predetermined characteristic, step 201. The images may be divided into clusters based on time the images were captured, metadata associated with an image or, alternatively, their visual properties. Further, metadata such as GPS data, or high level features such as recognition of faces or objects may be used as a basis to cluster images.

To cluster the images that are visually similar, the captured images are analyzed using known content analysis algorithms. In an embodiment, this may be achieved by extracting low-level features, such as luminance; colour information like hue and MPEG 7 dominant colour; colour distribution features like MPEG 7 colour layout and colour structure; and texture features like edges. The distance between each extracted feature is determined. The degree of similarity between the images is the determined distance. Therefore, images are clustered having a determined distance which is less than a predetermined threshold, resulting in clusters of images that are visually very similar. This may be achieved by comparing the distance of one feature or a combination of features in clustering the plurality of images. The features may be combined by a simple summation and the elements of the summation may be weighted. These clusters are provide to the selector 107 and at least one cluster is selected, step 203, based upon the number of images in a cluster. In an embodiment, the cluster having the largest number of images is selected. This cluster will have the largest amount of similar images and as such is more likely to contain an important or popular object/scene. In the event that multiple clusters have the largest size, the cluster having the least amount of (visual) variation within the cluster is selected. This assures that the images in the selected cluster are even more alike than in the other clusters. The selector 107 then selects at least one image from the selected cluster that best represents the images of the plurality of the images (the entire group of images), step 205. In an embodiment, the image which best represents the entire group of images is selected as the image closest to the centroid. The centroid is a virtual representation, in terms of features, of the average of the cluster. The image which best represents the entire group of images may be selected on the basis of a particular desired feature, for example, quality of the image such as sharpness/blur contrast or, the presence of a face in which eyes are open or the person is smiling etc.

In an alternative embodiment, the plurality of images may be clustered in step 201, by making use of Exchangeable Image File (EXIF) date information if available. Firstly, the images are grouped based on the time the images were captured. For example, a group of images can be created such that the time difference between the consecutive images is no more than a certain relatively small threshold (e.g. 2 up to 10 minutes) i.e. images captured within a predetermined time interval. Such images are captured around the same time and are likely to be images of the same object, scene or event. Next, the images of each group that are visually similar are clustered as described above. This clustering may be achieved with a higher threshold than normally, i.e., each individual cluster can allow for more visual variability, since the time information already assures that the images are related. In this way the visual clustering algorithm uses the previous cluster (based on time) as input rather than all the separate images enabling the visual clustering algorithm to operate faster and more efficiently. Using time information as a first clustering step prevents images that are semantically unrelated but visually very similar being clustered together. For example, using visual clustering only, two images of the sea captured during two different holiday trips may be clustered together.

In a further embodiment, the most representative image or images may be selected on the basis of whether or not the images contain a face. If most of the images in the cluster do not contain faces, the most representative image(s) should preferably also not contain faces. Likewise, if most of the images in the cluster do contain faces, the most representative image(s) should preferably also contain a face. For example if one has a trip with many sceneries (landscapes, cityscapes, etc), but one evening the user captures many images of his/her child doing something funny, the largest cluster is likely to be the one with the child. However, the user probably identifies the set of images much more with the location and scenery, and a representative image selected from the scenery would therefore be more appropriate. On the other hand, if the set is for example images captured at a birthday party, an image of the celebrating person(s) would most likely be a correct representative image for the event. Face detection can thus help identify the image or images that best represent the entire group of images.

The selected representative image can then be used for browsing a large collection of images, for example, a timeline can be used to represent a collection of thousands of images captured over the years. If a given time period is represented by a selected image that best represented the time period (according the embodiments above), browsing the whole collection can be as simple as browsing the representative images. If a user wants to see more of a specific time period, the interval can be split into smaller intervals with again selecting a representative image for each interval.

Using (EXIF) date information and clustering the image as described above enables the user to automatically detect where there are image capturing “peaks” in a collection, i.e., points in time where a user captured relatively many images. These peaks typically correspond to special events, like holidays, or birthdays or a day at the zoo. Where a timeline would, ordinarily take all images into account, using only the peaks the collection is summarized to the events that took place over the years. With an image or images that are representative for each event, providing an ideal summary of a collection. One can select all events, or for example only peaks that span multiple days. In the first case one day events are included, like birthdays and daytrips, while in the latter case only multiple days' events are displayed, like holidays.

Moreover, instead of choosing one image representing a group of images, the same method can also be used to select a given amount of images to represent the group. Rather than taking only one image from the largest cluster, one can take one image per cluster for the n largest clusters where n is the desired number of representatives.

Although embodiments of the present invention have been illustrated in the accompanying drawings and described in the foregoing detailed description, it will be understood that the invention is not limited to the embodiments disclosed, but is capable of numerous modifications without departing from the scope of the invention as set out in the following claims.

‘Means’, as will be apparent to a person skilled in the art, are meant to include any hardware (such as separate or integrated circuits or electronic elements) or software (such as programs or parts of programs) which reproduce in operation or are designed to reproduce a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program product’ is to be understood to mean any software product stored on a computer-readable medium, such as a floppy disk, downloadable via a network, such as the Internet, or marketable in any other manner.

1. A method of selecting at least one representative image from a plurality of images, the method comprising the steps of:
dividing (201) the plurality of images into clusters according to a predetermined characteristic of the content of said plurality of images;
selecting (203) at least one of the clusters based on the number of images in each of the clusters; and
selecting (205) at least one image from said selected at least one cluster as the representative image.

2. A method according to claim 1, wherein the step of selecting at least one cluster comprises the step of:
selecting the cluster having the largest number of images.

3. A method according to claim 2, wherein the step of selecting at least one cluster further comprises the step of:
selecting the cluster having the least amount of variation in said predetermined characteristic.

4. A method according to claim 1, wherein the step of selecting at least one image from said selected at least one cluster comprises the step of selecting one image from said selected at least one cluster as said representative image.

5. A method according to claim 1, wherein the step of dividing a plurality of images into clusters comprises the step of:
clustering images having similar characteristics.

6. A method according to claim 5, wherein the step of clustering images having similar characteristics comprises the step of:
clustering images that are visually similar.

7. A method according to claim 1, wherein the step of dividing a plurality of images into clusters comprises the step of:
clustering images captured at a time within a predetermined time interval.

8. A method according to claim 6, wherein the step of clustering images that are visually similar is preceded by the step of:
clustering images captured at time within a predetermined time interval; and
the step of clustering images that are visually similar comprises the step of:
clustering images of said cluster of images captured at time within a predetermined time interval that are visually similar.

9. A method according to claim 5, wherein the step of clustering images having similar characteristics comprises the step of:
extracting at least one feature from each of said plurality of images;
determining the distance between at least one extracted feature of each of said plurality of images; and
clustering images having a distance below a predetermined threshold.

10. A method according to claim 8, wherein said at least one feature comprises one of luminance; colour information; colour distribution features; texture features.

11. A method according to claim 1, wherein the step of selecting at least one image from said selected at least one cluster as a representative image comprises the step of:
selecting the image closest to a centroid of said selected at least one cluster.

12. A method according to claim 1 wherein the step of selecting at least one image from said selected at least one cluster as a representative image comprises the steps of:
determining the presence of at least one face within each of said images of said selected at least one cluster;
determining the ratio of the number of images which contain at least one face to the number of images that contain no face;
selecting an image having a face if said ratio is greater than or equal to 1 or selecting an image without a face if said ratio is less than to 1.

13. A computer program product comprising a plurality of program code portions for carrying out the method according to claim 1.

14. Apparatus (100) for selecting at least one representative image from a plurality of images, the apparatus (100) comprising:
a divider (105) for dividing the plurality of images into clusters according to a predetermined characteristic of the content of said plurality of images;
a selector (107) for selecting at least one of the clusters based on the number of images in each of the clusters and for selecting at least one image from said selected at least one cluster as the representative image.
